(19) United States
(12) Patent Application Publication
(10) Pub. No.: US 2012/0007554 A1
(43) Pub. Date: Jan. 12, 2012

(54) VEHICULAR CHARGE APPARATUS

(75) Inventors: Takashi KANAMORI, Nagoya-city (JP); Hiroshige ASADA, Nagoya-city (JP); Shinya TAGUCHI, Kariya-city (JP)

(73) Assignee: DENSO CORPORATION, Kariya-city (JP)

(21) Appl. No.: 13/173,555

(22) Filed: Jun. 30, 2011

(30) Foreign Application Priority Data
Jul. 8, 2010 (JP) 2010-156089

(51) Int. Cl. H02J 7/04; H02J 7/00

(52) U.S. Cl. 320/109; 320/162

(57) ABSTRACT

A vehicular charge apparatus for externally charging an in-vehicle battery of a vehicle includes a charger. The charger includes an in-charger detection section, which detects a charge needed state of a subject vehicle prior to a charge connection of a charger connector of the charger to an in-vehicle charge inlet of the subject vehicle. In the charge needed state, an electric charge is necessary for the vehicle. When the charge needed state of the subject vehicle is determined, a charger controller of the charger begins a charge preparation operation needed in the charger while transmitting charge information that indicates that the subject vehicle is in the charge needed state via an in-charger communicator to an in-vehicle communicator. When the in-vehicle communicator receives the charge information, a charge preparation section of the subject vehicle begins a charge preparation operation necessary in the subject vehicle.

### CROSS REFERENCE TO RELATED APPLICATION

The present application is based on and incorporates herein by reference Japanese Patent Application No. 2010-156089 filed on Jul. 8, 2010.

### FIELD OF THE INVENTION

The present invention relates to a vehicular charge apparatus for externally charging an in-vehicle battery of a vehicle such as an electric vehicle and a plug-in hybrid vehicle.

### BACKGROUND OF THE INVENTION

[Patent document 1] JP-2002-123888 A (JP-3997703)

[Non-patent document 1] i-MIEV Instruction Manual from Mitsubishi Motors Corporation issued in September, 2009

There is conventionally known a charge apparatus for vehicles as indicated in Patent document 1. The vehicular charge apparatus for vehicles in Patent document 1 includes a charging paddle for supplying an electric power to an in-vehicle battery, and a charger information transmission device to transmit information of the charger to the vehicle. In addition, the vehicle includes a charge controller to control a charging operation to the in-vehicle battery, and a packet communication terminal to transmit information about the battery to a charge management apparatus positioned at a remote place.

When the charging paddle is inserted in a paddle slot for charge of the vehicle, the packet communication terminal of the vehicle communicates with the charger information transmission device of the charger to start a monitor of the charge information, and transmits the state of the charger and charge information to the charge management apparatus. In addition, the charge management apparatus exchanges data with the packet communication terminal periodically during the charging so as to monitor the vehicle information and the charge information. When the charging paddle is removed from the paddle slot, the packet communication terminal switches over into a sleeping state.

In the vehicular charge apparatus for vehicles in Patent document 1, the charge is started when the charging paddle is inserted in the paddle slot. The charge control can be started without executing a special control. In addition, the state of the charger and the charge state of the vehicle can be monitored from the charge management apparatus positioned distant from the charger (i.e., vehicle station). A routine inspection by an operator can be made unnecessary, making the vehicle station for charge unmanned.

However, in such a conventional technology, the charge is triggered by inserting the charging paddle in the paddle slot. Any action that is operated or prepared before the start of the charge is undetectable.

In addition, in the actual charging, before inserting the charging paddle in the paddle slot, a user needs to make a preparation as follows:
1) certainly applying a parking brake to a vehicle;
2) shifting a selector for transmission of the vehicle to a parking position “P”;
3) turning off electrical devices such as a light and an air-conditioner;
4) turning a power switch to “LOCK”;
5) pulling a lever in a vehicle compartment to open a charge inlet;
6) opening an inner lid; and
7) inserting a charge cable in the electric socket (for example, see Non-patent document 1). The preparation operation prior to charge may be troublesome for users.

### SUMMARY OF THE INVENTION

The present invention takes the above problem into consideration. It is an object of the present invention to provide a vehicular charge apparatus to enable a prior detection of an action of a user, who intends to charge, beforehand and reduce a troublesomeness in the charge operation of the user.

To achieve the above object, according to an example of the present invention, a vehicular charge apparatus including a charger is provided for supplying an electric power to charge an in-vehicle battery mounted in a vehicle after a user completes a charge connection, which connects a charger connector of the charger with an in-vehicle charge inlet of the vehicle. The charger includes the following: a detection section that detects, of the vehicle, a charge needed state in which an electric charge is needed for the vehicle, prior to completing the charge connection of the charger connector with the in-vehicle charge inlet; an in-charger communicator that communicates with an in-vehicle communicator in the vehicle; and an in-charger controller that controls an operation of an electric charge. Herein, when the detection section detects the charge needed state of the vehicle, the in-charger controller executes a charge preparation operation necessary in the charger, and transmits charge information, which indicates that the vehicle is in the charge needed state, via the in-charger communicator to the in-vehicle communicator, causing an in-vehicle charge preparation section in the vehicle to begin a charge preparation operation necessary in the vehicle when the in-vehicle communicator receives the charge massage from the in-charger communicator.

Under such a configuration, at an earlier stage prior to the charge connection of the charger connector to the in-vehicle charge inlet, the detection section detects the charge needed state. Compared with a conventional technology, a preparation operation for charge can be begun from the earlier stage and the end time of the charge can be hastened or brought forward. When the detection section detects that it is in the charge needed state of the vehicle, preparation operations necessary for the charge are automatically begun in the charger and vehicle, respectively. This can reduce a troublesomeness of the user in the case of charging the vehicle.

According to another example of the present invention, a method is provided for supplying from a charger an electric power to charge an in-vehicle battery mounted in a vehicle after a user completes a charge connection, which connects a charger connector of the charger with an in-vehicle charge inlet of the vehicle. The charger includes an in-charger controller and an in-charger communicator while the vehicle includes an in-vehicle controller and an in-vehicle communicator. The method includes the following: determining by the in-charger controller using a detection section, a charge needed state in which an electric charge is needed for the vehicle, prior to completing the charge connection of the charger connector with the in-vehicle charge inlet; executing by the in-charger controller a charge preparation operation necessary in the charger for the charge when the charge needed state is determined; transmitting by the in-charger controller charge information, which indicates that the vehicle is in the charge needed state, via the in-charger communicator to the in-vehicle communicator when the charge needed state is determined; receiving by the in-vehicle controller via the in-vehicle communicator the charge information from the charger; and executing by the in-vehicle controller using an in-vehicle charge preparation section of the vehicle a charge preparation operation necessary in the vehicle for the charge when the charge massage is received.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram illustrating a configuration of a vehicular charge apparatus according to a first embodiment of the present invention;

FIG. 2 is a flowchart diagram illustrating a charge process of the first embodiment;

FIG. 3 is a diagram illustrating a configuration of a vehicular charge apparatus according to a second embodiment of the present invention;

FIG. 4 is a flowchart diagram illustrating a charge process of the second embodiment;

FIG. 5 is a diagram illustrating a configuration of a vehicular charge apparatus according to a third embodiment of the present invention;

FIG. 6 is a flowchart diagram illustrating a charge process of the third embodiment;

FIG. 7 is a diagram illustrating a configuration of a vehicular charge apparatus according to a fourth embodiment of the present invention;

FIG. 8 is a flowchart diagram illustrating a charge process of the fourth embodiment;

FIG. 9 is a diagram illustrating a configuration of a vehicular charge apparatus according to a fifth embodiment of the present invention;

FIG. 10 is a flowchart diagram illustrating a charge process of the fifth embodiment;

FIG. 11 is a diagram illustrating a configuration of a vehicular charge apparatus according to a sixth embodiment of the present invention;

FIG. 12 is a flowchart diagram illustrating a charge process of the sixth embodiment;

FIG. 13 is a diagram illustrating a configuration of a vehicular charge apparatus according to a seventh embodiment of the present invention;

FIG. 14 is a flowchart diagram illustrating a charge process of the seventh embodiment;

FIG. 15 is a diagram illustrating a configuration of a vehicular charge apparatus according to an eighth embodiment of the present invention;

FIG. 16 is a flowchart diagram illustrating a charge process of the eighth embodiment;

FIG. 17 is a diagram illustrating a configuration of a vehicular charge apparatus according to a ninth embodiment of the present invention; and

FIG. 18 is a flowchart diagram illustrating a charge process of the ninth embodiment.

### DETAILED DESCRIPTION OF THE PREFERRED EMBODIMENTS

The following explains several embodiments with reference to the drawings. Each embodiment may have a portion corresponding to that of a precedent embodiment; such a portion is assigned with an identical reference number so as to omit overlapped explanation. When only a portion of the configuration of each embodiment is explained, the other portions of the configuration may adopt those of the preceding embodiment previously explained. Partial combination between the embodiments may be possible with respect to not only a portion which is explicitly described in each embodiment, but also a portion which is not explicitly described if any trouble does not arise.

### First Embodiment

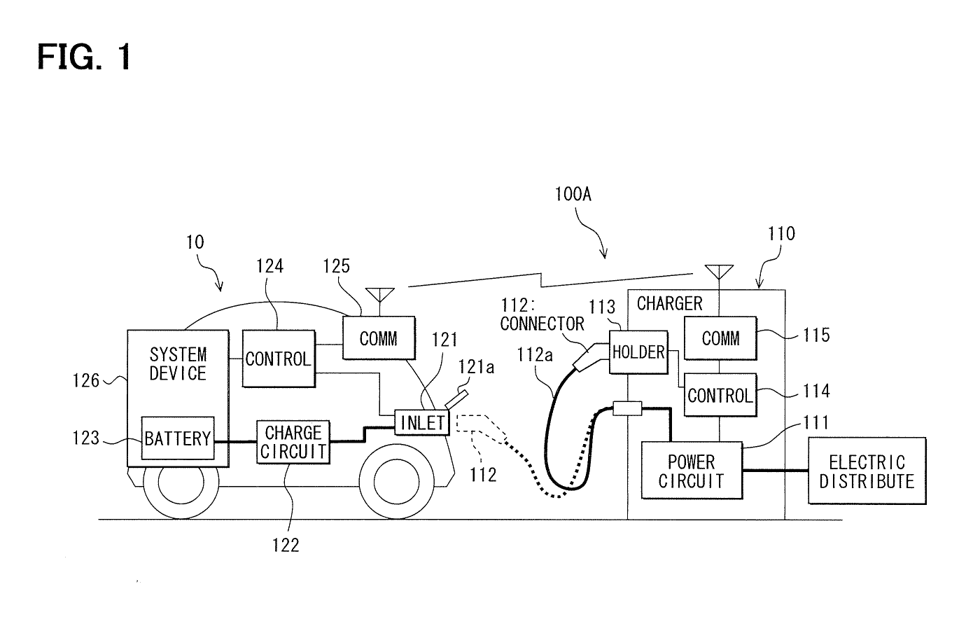

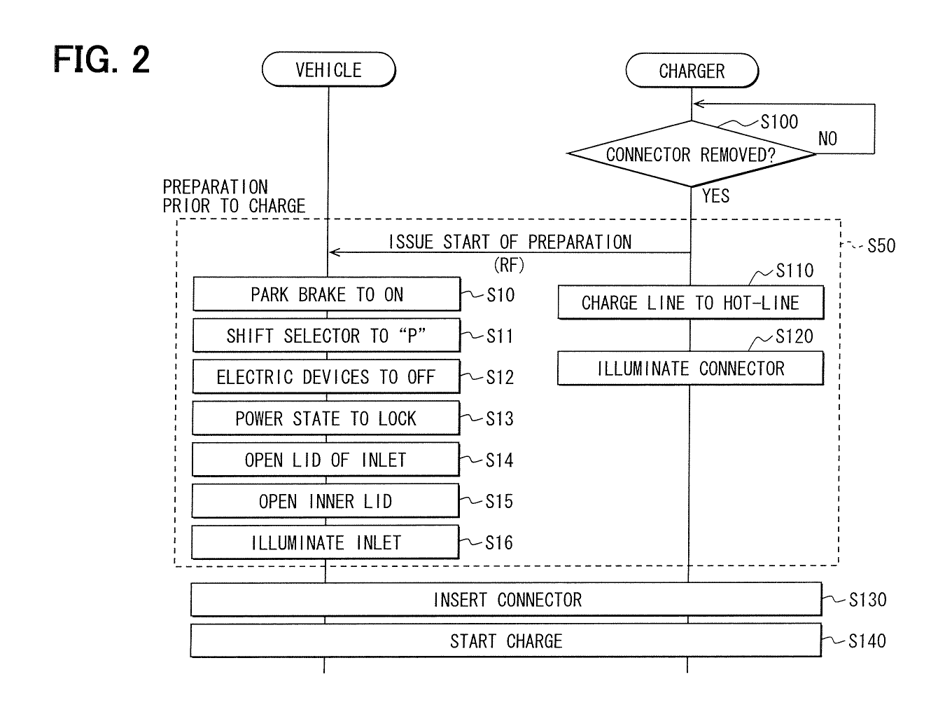

In a first embodiment of the present invention, a vehicular charge apparatus 100 for vehicles is directed to a vehicular charge apparatus 100 (100A) for externally charging an in-vehicle battery of a vehicle such as an electric vehicle (EV) or a plug-in hybrid vehicle (PHV). The following will explain a basic configuration of the vehicular charge apparatus 100A with reference to FIG. 1 and FIG. 2. FIG. 1 is a schematic view indicating the vehicular charge apparatus 100A. FIG. 2 is a flowchart diagram illustrating a charge process in the vehicular charge apparatus 100A.

The vehicular charge apparatus 100A is arranged in a charge station that serves as a charge facility and executes a quick charge. When needing a short time charge (e.g., thirty minute charge), a user drives a vehicle 10 to the charge station, charging the vehicle. The charge station is installed nationwide, for example, in a highway service area, gas station, car dealer, pay parking lot, shopping center, etc.

The vehicular charge apparatus 100A includes a charger 110. The charger 110 contains a power circuit 111, a charger connector 112, a connector holder 113, a controller 114 (also referred to an in-charger controller), and a communicator 115 (also referred to as an in-charger communicator). In addition, a vehicle 10 which is a target of charge (also referred to as a subject vehicle) includes various in-vehicle devices needed for charge. Such various devices include a charge inlet 121 (also referred to as a receiver), a charge circuit 122 (also referred to as an in-vehicle charger), a battery 123 (also referred to an in-vehicle battery), a controller 124 (also referred to as an in-vehicle controller), a communicator 125 (also referred to as an in-vehicle communicator), and a system device 126.

First, the constituent elements or devices in the charger 110 will be explained in order. The power circuit 111 includes an AC-DC conversion function which converts a system power (e.g., three phase alternating current 200V) into a direct current power (e.g., direct current 500V). The system power is supplied to the charger 110 of the charge station via an electricity distribution of an electrical grid. The AC-DC conversion function supplies the post-conversion electric DC power to the charger connector 112 while adjusting to the current flow according to a charge amount of the in-vehicle battery 123.

The charger connector 112 is an electric power supply device which supplies the electric power converted by the power circuit 111 to the in-vehicle battery 123. The charger connector 112 has a cable 112a which enables an extension to a position distant from the power circuit 111 by a predetermined length. The power circuit 111, the cable 112a, and the charger connector 112 are included in a charge link (or referred to as a charge line).

The charger connector 112 is held in the connector holder 113 when the charge is not executed (also referred to as a non-charge state). In addition, when the charge is executed (also referred to as a charge state), the charger connector 112 is removed by a user from the connector holder 113 and inserted in the charge inlet 121 of the vehicle 10, thereby electrically connecting with the in-vehicle battery 123 via the charge circuit 122. In FIG. 1, a broken line indicates the charger connector 112 in the charge state; a solid line indicates the charger connector 112 in the non-charge state.

Furthermore, the charger connector 112 is equipped with a connector illuminator (unshown) at its tip portion. The connector illuminator is controlled by the in-charger controller 114 to turn on or off (also referred to as “turn into a lighting state or a non-lighting state” or “turn into an ON state or OFF state”).

The connector holder 113 is a holder portion which holds the charger connector 112 in the non-charge state. The connector holder 113 together with the in-charger controller 114 serves as a detection section to detect or determine whether a charge by the user is in a needed state or in an unneeded state with respect to the in-vehicle battery 123 of the vehicle 10. That is, when the charger connector 112 is removed from the connector holder 113 by the user for beginning a charge, the connector holder 113 outputs to the in-charger controller 114 a charge need signal (also referred to as a charge message) that indicates that it is in the charge needed state (i.e., in the state where the user is going to begin a charge). The charge need signal serves as charge information that indicates that it is in the charge needed state.

The in-charger controller 114 includes a known microcomputer and controls an operation of the power circuit 111, and detects or determines the charge needed state based on the charge need signal from the connector holder 113, issuing an instruction for making or beginning a preparation operation required for the charge in the charger 110 itself. Furthermore, the in-charger controller 114 communicates with the vehicle 10 via the in-charger communicator 115, issuing an instruction for making or beginning a preparation operating required for the charge in the vehicle 10 by transmitting a charge need signal serving as the charge information that indicates that it is in the charge needed state.

The in-charger communicator 115 transmits a signal outputted from the in-charger controller 114 to the in-vehicle communicator 125, and receives a signal transmitted from the in-vehicle communicator 125, outputting the received signal to the in-charger controller 114.

Next, the constituent elements or devices in the subject vehicle 10 will be explained in order.

The charge inlet 121 is arranged, for instance, at a front portion of the vehicle 10 to serve as a connection portion for charge in which the above charger connector 112 is inserted. The charge inlet 121 is accommodated in a space formed inside of a body (outer plate) of the vehicle 10. The lid portion 121a is formed in the body so as to cover or uncover the space accommodating the charge inlet 121. Furthermore, an inner lid (unshown) is provided at an end of the charge inlet 121 so as to uncover and cover the connection portion that is to be connected with the charger connector 112.

The lid portion 121a and the inner lid are in a closed state in the non-charge state (i.e., usually) and in an opened state in the charge state. This lid portion 121a and inner lid are controlled in the charge state by the in-vehicle controller 124 so as to be in the opened state.

Furthermore, an indicator light (also referred to as an illuminator, unshown) is provided in a space accommodating the charge inlet 121 to be controlled by the in-vehicle controller 124 to turn on or off.

The charge circuit 122 charges the battery 123 using an electric power supplied from the charger connector 112 of the charger 110. The charge circuit 122 has a DC-DC conversion function which adjusts the voltage of the DC electric power after the conversion by the power circuit 111 to charge the battery 123. The battery 123 is a battery for travel or running to supply an electric power to a motor for travel of the vehicle 10.

The in-vehicle controller 124 includes a known microcomputer and controls an operation in the vehicle 10 in the charge state or during the charging. The in-vehicle controller 124 controls opening and closing of the lid portion 121a and inner lid of the charge inlet 121, and an operation of the system device 126 based on a signal received via the in-vehicle communicator 125.

The in-vehicle communicator 125 receives a charge need signal outputted from the in-charger communicator 115, and outputs the received signal to the in-vehicle controller 124.

The system device 126 severs as a charge preparation section to make a preparation operation necessary for the vehicle 10 in the charge state. According to the present embodiment, the system device 126 includes the following: a parking brake operation portion to switch a parking brake or emergency brake into an ON state or an OFF state; a selector change portion to change a selector position; an electric power stop portion to stop an electric power supply to all the in-vehicle electrical devices such as a headlight, and an air-conditioner mounted in the vehicle 10; and a lock portion to change a power switch into a lock position. An operation of the system device 126 is controlled by the in-vehicle controller 124.

Next, an operation of the vehicular charge apparatus 100A based on the above configuration will be explained using FIG. 2.

It is further noted that a flowchart or the processing of the flowchart in the present application includes sections (also referred to as steps), which are represented, for instance, as S100. Further, each section can be divided into several sub-sections while several sections can be combined into a single section. Furthermore, each of thus configured sections can be referred to as a means or module.

First, at S100, the in-charger controller 114 of the charger 110 determines or detects whether the charger connector 112 is removed from the connector holder 113. When the charger connector 112 is removed from the connector holder 113 by the user in order to execute a charge to the battery 123, the in-charger controller 114 detects that the charger connector 112 is removed from the connector holder 113 based on the charge need signal outputted by the connector holder 113, thereby determining that for the charger 110 it is in the charge needed state. Then, preparation operations needed as a preceding operation prior to the charge are executed individually in both the vehicle 10 and the charger 110 based on a sequence of preparation operations prior to charge, which is indicated as S50.

That is, the in-charger controller 114 transmits a charge need signal serving as charge information that indicates that it is in the charge needed state (i.e., the subject vehicle 10 and the charger 110 are in the charge needed state) from the in-charger communicator 115 to the in-vehicle communicator 125. In specific, the charge information (i.e., the charge need signal) includes an instruction signal to request a start of a sequence prior to charge. This instruction signal may be also referred to as a prior-charge sequence start signal.

Then, in the vehicle 10, the prior-charge sequence start signal is transmitted from the in-vehicle communicator 125 to the in-vehicle controller 124. The in-vehicle controller 124 makes a preparation operation necessary for the charge in the vehicle 10. That is, the in-vehicle controller 124 controls the system device 126 to process S10 to S16 based on the received prior-charge sequence start signal.

That is, at S10, the in-vehicle controller 124 operates the parking brake operation portion to turn the parking brake into an ON state. At S11, the selector change portion is operated to change the selector position to the parking position (P). At S12, the electric power stop portion is operated to stop the operation of all the in-vehicle electrical devices such as a headlight and an air-conditioner. At S13, the lock portion is operated to change the power switch into the lock position. At S14, the lid portion 121a of the charge inlet 121 is switched into the opened state. At S15, the inner lid of the charge inlet 121 is switched into the opened state. Furthermore, at S16, the indicator light in the space accommodating the charge inlet 121 is turned on or turned into the lighting state.

In contrast, the in-charger controller 114 of the charger 110 makes a preparation operation necessary for the charge in the charger 110. That is, at S110, the charge link containing all the power circuit 111, the cable 112a, and the charger connector 112 is switched into a hot-link state (also referred to as a hot-line state), which is a state enabling a charge for the vehicle 10. In addition, at S120, the connector illuminator provided in the charger connector 112 is turned on or turned into the lighting state.

At S130, the charger connector 112 is connected or inserted to the charge inlet 121 by the user, then starting the charge at S140.

As explained above, in the present embodiment, in a stage prior to the user's connection of the charger connector 112 to the charge inlet 121 of the vehicle 10, the detection section (i.e., the connector holder 113 and the in-charger controller 114) detects whether it is in the charge needed state or not. When the detection section detects that it is in the charge needed state of the vehicle, the charge needed signal (prior-charge sequence start signal) which indicates that it is in the charge needed state is sent to the in-vehicle communicator 125 from the in-charger communicator 115. In the vehicle 10, the in-vehicle controller 124 receives the charge needed signal, and each of the various portions of the system device 126 makes a preparation operation necessary for the charge in the vehicle 10 automatically. In the charger 110, the in-charger controller 114 makes a preparation operation necessary for the charge in the charger 110 automatically.

Thus, in the stage prior to the user's connection of the charger connector 112 to the charge inlet 121 of the vehicle 10, the detection section can detect that it is in the charge needed state of the vehicle. As compared with a conventional technology, a preparation operation necessary for the charge can be started from an early stage. The time-to-completion (i.e., an end time) of charge or the charge completion clock time can be thus speeded. When the detection section detects that it is in the charge needed state of the vehicle, the preparation operations necessary for the charge can be automatically started individually in both the vehicle 10 and charger 110. Such a configuration can reduce a troublesomeness of the user in the case of charging the vehicle.

In the present embodiment, the above detection section is shared by the connector holder 113 and the in-charger controller 114. That is, when the charger connector 112 is removed by the user from the connector holder 113, the charge needed state is detected. Therefore, using a simple configuration where the charger connector 112 is removed from the connector holder 113 enables the detection of the charge needed state in the stage prior to the connection of the charger connector 112 to the charge inlet 121 in the vehicle 10.

In addition, the preparation operations necessary for the charge in the vehicle 10 include the following: turning on a parking brake (i.e., applying a parking brake); shifting a selector for transmission to a parking position (P); stopping operations of the in-vehicle electrical devices such as a headlight and an air-conditioner; changing the power switch into the lock position; changing the lid portion 121a of the charge inlet 121 into the opened state; changing the inner lid of the charge inlet 121 into the opened state; and turning on the indicator light in the charge inlet 121. Thus, the preparation operations which the user has to perform or manipulate in a conventional technology can be automatically executed in the present embodiment. Such a configuration can reduce a troublesomeness of the user in the case of charging the vehicle.

Furthermore, the preparation operations in the charger 110 include changing the charge link into the hot-link state, and turning on the connector illuminator. Thus, similarly, the preparation operations which the user has to perform or manipulate in a conventional technology can be automatically executed in the present embodiment. Such a configuration can reduce a troublesomeness of the user in the case of charging the vehicle.

### Second Embodiment

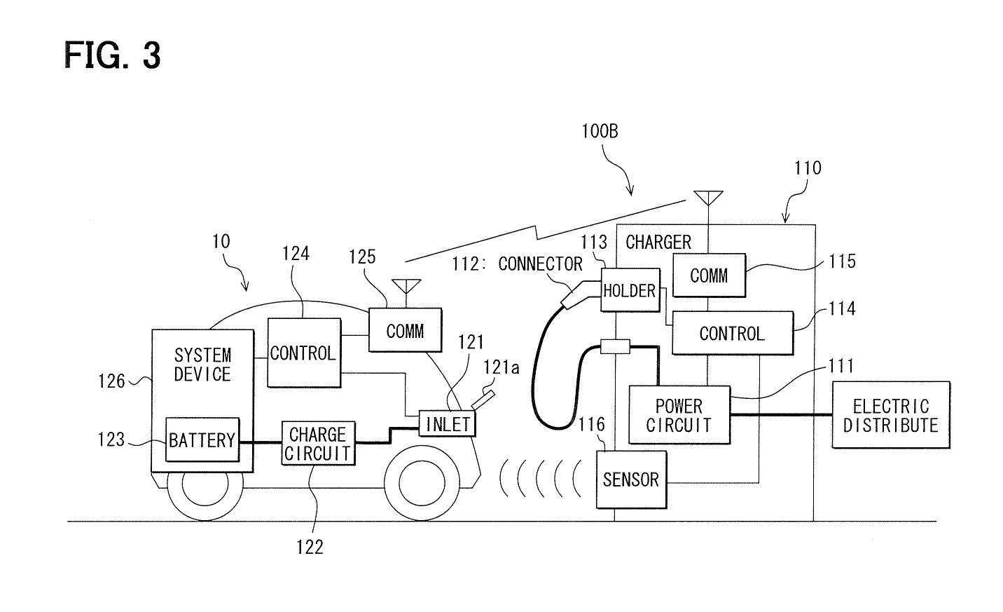

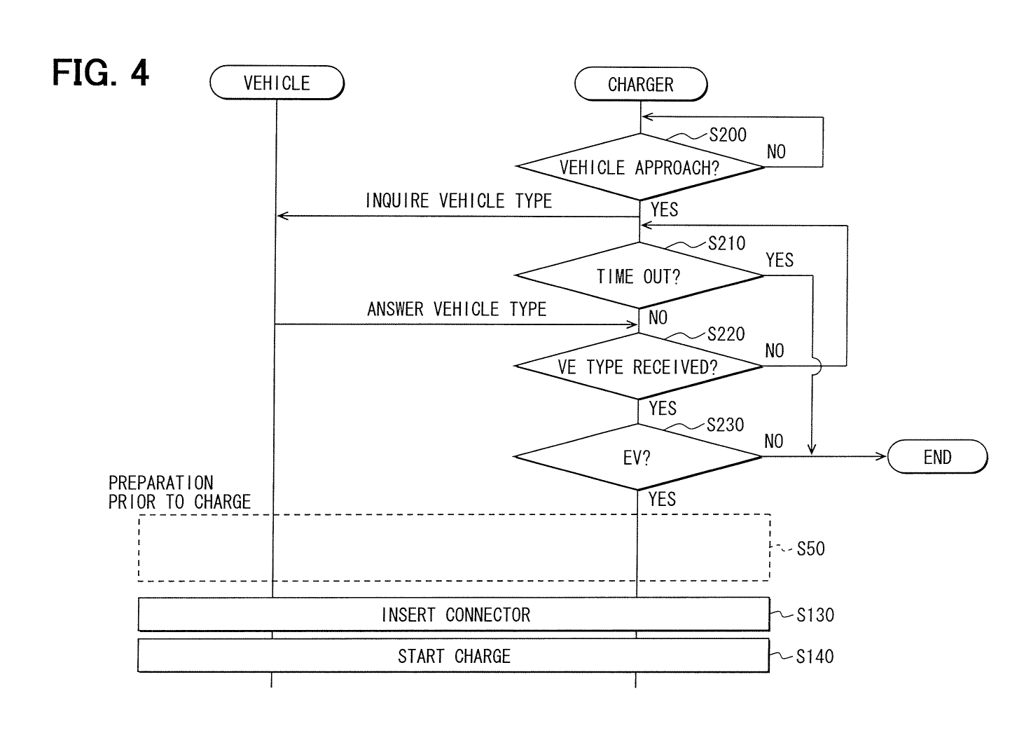

The vehicular charge apparatus 100 (100B) of a second embodiment will be explained with reference to FIG. 3 and FIG. 4. In the second embodiment, the detection section which detects that it is in the charge needed state is different from that of the above first embodiment (FIG. 1, FIG. 2).

The detection section of the second embodiment includes a sensor 116 and the in-charger controller 114, as illustrated in FIG. 3. The sensor 116 is provided in the charger 110 for detecting a presence or absence of the vehicle 10 within a predetermined distance from the charger 110. The sensor 116 makes it detectable whether the vehicle 10 approached an area within the predetermined distance to the charger 110. For example, in the case that the vehicle 10 needing a charge approaches the charger 110 and stops at a specified position around the charger 110, the sensor 116 detects that the vehicle 10 approaches. The sensor 116 outputs an approach signal, which indicates that the vehicle 10 approaches, to the in-charger controller 114. When receiving the signal, the in-charger controller 114 detects that it is in the charge needed state.

In addition, the in-vehicle controller 124 of the vehicle 10 previously stores electric vehicle (EV) information, which indicates that the present vehicle 10 is an electric vehicle (including a plug-in hybrid vehicle (PVH) which is driven by a motor for travel and needs a charge when the electric power of the in-vehicle battery 123 is exhausted.

When receiving the approach signal pertinent to the vehicle 10, the in-charger controller 114 makes an inquiry as to whether a type of the vehicle 10 is an electric vehicle between the in-charger communicator 115 and the in-vehicle communicator 125. When the vehicle 10 is or belongs to the electric vehicle, the preparation operations needed before charge are executed in the vehicle 10 and charger 110, based on the sequence prior to charge (S50).

When multiple chargers 110 are installed at the charge station, the inquiry of the vehicle type of the vehicle 10 needs to be made in one to one correspondence between the charger 110 and the vehicle 10. The communications between the in-charger communicator 115 and the in-vehicle communicator 125 is preferably made using a vicinity wireless communications link, for instance, within one meter, or using a wireless communications link or an optical communications link with a directionality. The following will explain the details of the control concerning the charge preparation operation with reference to FIG. 4.

First, at S200, the in-charger controller 114 determines whether the vehicle 10 approaches based on the approach signal from the sensor 116. When determining that the vehicle 10 approaches, the in-charger controller 114 makes an inquiry of a vehicle type of the vehicle 10 from the in-charger communicator 115 to the in-vehicle communicator 125. That is, it confirms whether the vehicle 10 belongs to an electric vehicle. At this time, the in-charger controller 114 starts an elapsed time counter for detecting or measuring an elapsed time.

At S210, the in-charger controller 114 determines whether the elapsed time detected by the counter exceeds a predetermined time to cause the counter to stop. When the counter does not stop at S210, it is determined at S220 whether a reply of the information is received from the in-vehicle communicator 125. When it is determined that the reply of the information is received from the vehicle 10 at S220, it is determined at S230 whether the information is the EV information. When it is determined at S230 that it is the EV information, the preparation operations needed before charge are executed in the vehicle 10 and charger 110, based on the sequence prior to charge (S50), like in the first embodiment. With the affirmative determination at S210 or the negative determination at S230, the in-charger controller 114 regards or determines that the approaching vehicle 10 does not belong to an electric vehicle, thereby ending the present control.

In the present embodiment, the detection section includes the sensor 116 and the in-charger controller 114. An approach of the vehicle 10 within a predetermined distance from the charger 110 enables the detection of the charge needed state or the charge necessity. The preparation operation for charge can be attained or begun at a further earlier stage. Furthermore, the communications are made between the in-charger communicator 115 and the in-vehicle communicator 125, so as to confirm that the approaching vehicle 10 within the predetermined distance is an electric vehicle which needs charge, thereby detecting the necessity for charge. The detection about the necessity for charge can be made accurately.

### Third Embodiment

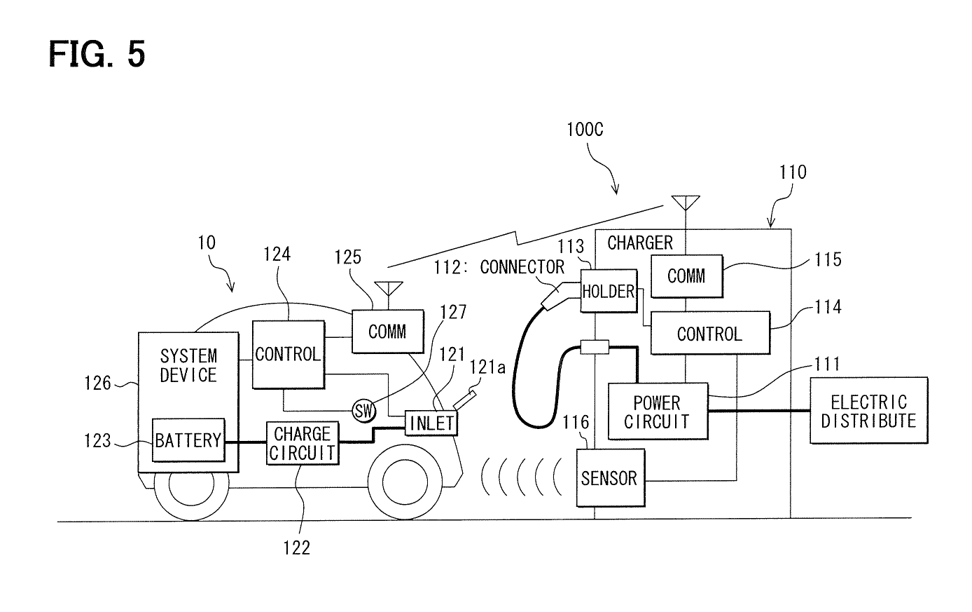

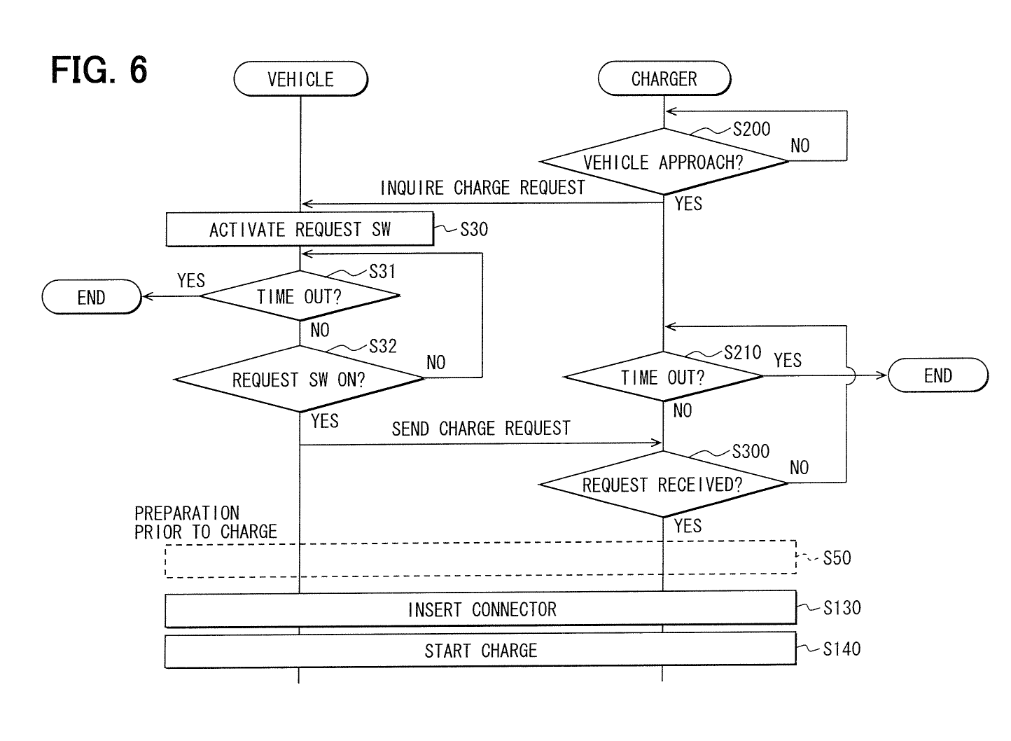

The vehicular charge apparatus 100 (100C) according to a third embodiment is illustrated in FIG. 5 and FIG. 6. In the third embodiment, the detection section which detects that it is in the charge needed state is different from that of the above second embodiment (FIG. 3, FIG. 4). As illustrated in FIG. 5, the detection section includes an in-vehicle charge request switch 127, the in-vehicle controller 124, the in-vehicle communicator 125, the in-charger communicator 115, and the in-charger controller 114.

The in-vehicle charge request switch 127 is a switch used for a user to indicate an intention to start a charge in case of executing the charge. For example, it is arranged near a driver's seat in an instrument panel of the vehicle 10. When turned into an ON state by the user, the charge request switch 127 outputs to the in-vehicle controller 124 a signal as in-vehicle charge request information which indicates a request of a charge in the vehicle 10. With an inquiry from the in-charger controller 114, the in-vehicle charge request information is transmitted by the in-vehicle controller 124 from the in-vehicle communicator 125 to the in-charger communicator 115. When receiving the in-vehicle charge request information, the in-charger controller 114 detects that it is in the charge needed state.

As explained above, when the in-charger controller 114 receives the in-vehicle charge request information, the preparation operations needed before charge are executed in the vehicle 10 and charger 110, based on the sequence prior to charge (S50). The following will explain the details of the control concerning the charge preparation operation with reference to FIG. 6.

First, at S200, the in-charger controller 114 determines whether the vehicle 10 approaches based on the approach signal from the sensor 116. When determining that the vehicle 10 approaches, the in-charger controller 114 makes an inquiry of a presence or absence of the in-vehicle charge request information from the in-charger communicator 115 to the in-vehicle communicator 125. At this time, the in-charger controller 114 starts an elapsed time counter for detecting an elapsed time. At S210, the in-charger controller 114 determines whether the elapsed time detected by the counter exceeds a predetermined time.

The charge request switch 127 in the vehicle 10 is turned into the active state (i.e., the ON state) at S30. At this time, the in-vehicle controller 124 starts an elapsed time counter for detecting an elapsed time.

At S31, the in-vehicle controller 124 determines whether the elapsed time detected by the counter exceeds a predetermined time. When the counter does not stop at S31, it is determined at S32 whether a user turns the charge request switch into the ON state. When the charge request switch 127 is turned into the ON state at S32, the in-vehicle controller 124 transmits the in-vehicle charge request information from the in-vehicle communicator 125 to the in-charger communicator 115.

In the charger 110, at the stage where the elapsed time counter is not stopped at S210, the in-charger controller 114 determines whether the in-vehicle charge request information is received from the in-vehicle controller 124 at S300. When determining that the in-vehicle charge request information is received, the preparation operations needed before charge are executed in the vehicle 10 and charger 110, based on the sequence prior to charge (S50), like in the first embodiment. With the affirmative determination at S210, the in-charger controller 114 regards or determines that the in-vehicle charge request information is not acquired before the counter is stopped, thereby ending the present control. With the affirmative determination at S31, the in-vehicle controller 124 regards or determines that the charge request switch 127 is not turned in the ON state before the counter is stopped, thereby ending the present control.

In the present embodiment, the detection section includes the in-vehicle charge request switch 127, the in-vehicle controller 124, the in-vehicle communicator 125, the in-charger communicator 115, and the in-charger controller 114. When the charge request switch 127 is turned into the ON state, the in-charger controller 114 receives the in-vehicle charge request information, thereby detecting that there is a necessity for charge. The necessity for charge reflecting the intention for the charge of the user is detectable.

### Fourth Embodiment

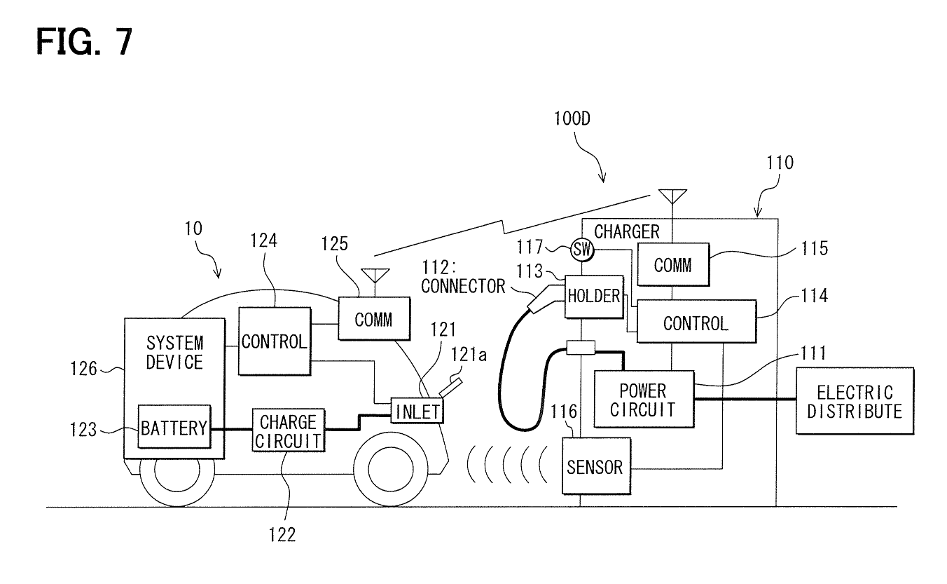

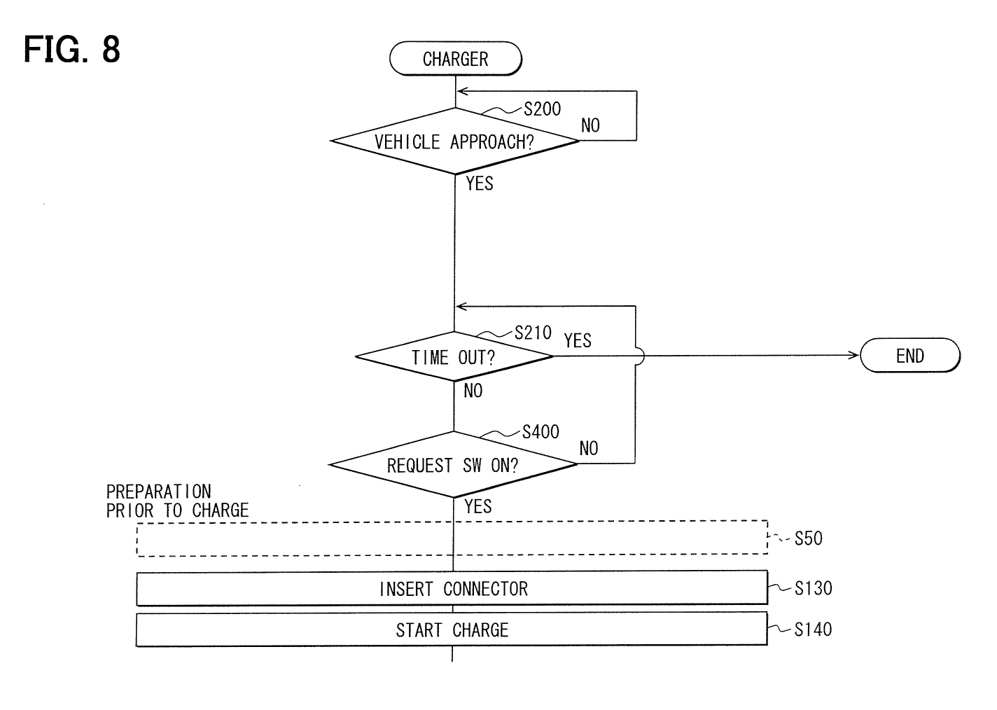

The vehicular charge apparatus 100 (100D) according to a fourth embodiment is illustrated in FIG. 7 and FIG. 8. In the fourth embodiment, the detection section which detects that it is in the charge needed state is different from that of the above third embodiment (FIG. 5, FIG. 6). The detection section includes an in-charger charge request switch 117 and the in-charger controller 114, as illustrated in FIG. 7.

The in-charger charge request switch 117 is a switch used for a user to indicate an intention to start a charge in case of executing the charge. For example, it is arranged on a side wall of the charger 110. When turned into an ON state by the user, the charge request switch 117 outputs to the in-charger controller 114 a signal as in-charger charge request information which indicates a request of a charge in the charger 110. When receiving the in-charger charge request information, the in-charger controller 114 detects that it is in the charge needed state.

As explained above, when the in-charger controller 114 receives the in-charger charge request information from the charge request switch 117, the preparation operations needed before charge are executed in the vehicle 10 and charger 110, based on the sequence prior to charge (S50). The following will explain the details of the control concerning the charge preparation operation with reference to FIG. 8.

First, at S200, the in-charger controller 114 determines whether the vehicle 10 approaches based on the approach signal from the sensor 116. When determining that the vehicle 10 approaches, the in-charger controller 114 starts the elapsed time counter for measuring an elapsed time, then proceeding to S210.

At S210, the in-charger controller 114 determines whether the elapsed time detected by the counter exceeds a predetermined time. With the negative determination at S210, the processing proceeds to S400. At S400, the in-charger controller 114 determines whether the charge request switch 117 is turned into the ON state. With the affirmative determination at S400, i.e., when it is determined that the in-charger charge request information arises, the preparation operations needed before charge are executed in the vehicle 10 and charger 110, based on the sequence prior to charge (S50), like in the first embodiment. With the affirmative determination at S210, the in-charger controller 114 regards or determines that the in-charger charge request information is not acquired before the counter is stopped, thereby ending the present control.

In the present embodiment, the detection section includes the in-charger charge request switch 117 and the in-charger controller 114. When the charge request switch 117 is turned into the ON state, the in-charger controller 114 receives the in-charger charge request information, thereby detecting the charge needed state in which there is a necessity for charge. Like in the third embodiment, the necessity for charge reflecting the intention for the charge of the user is detectable.

### Fifth Embodiment

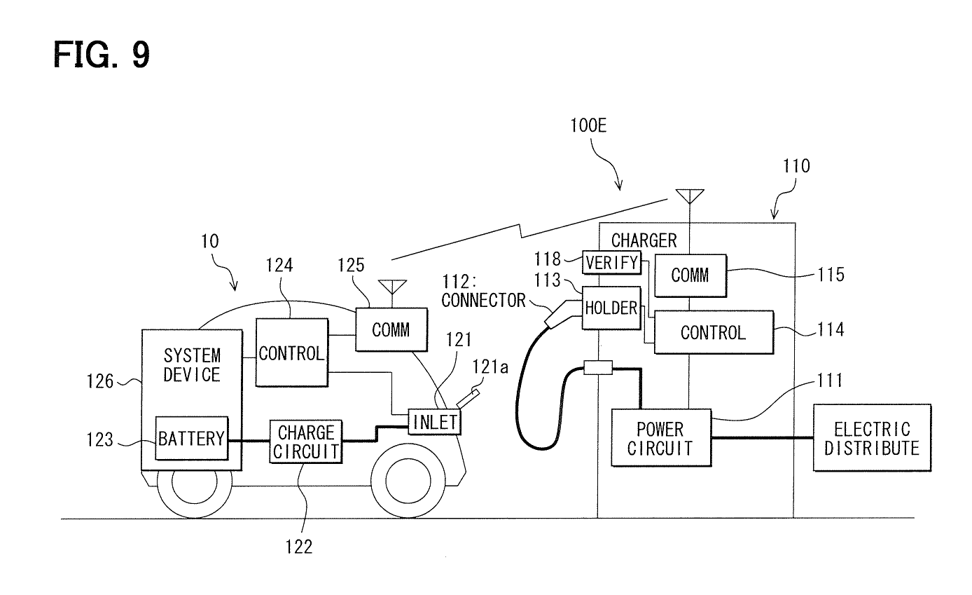

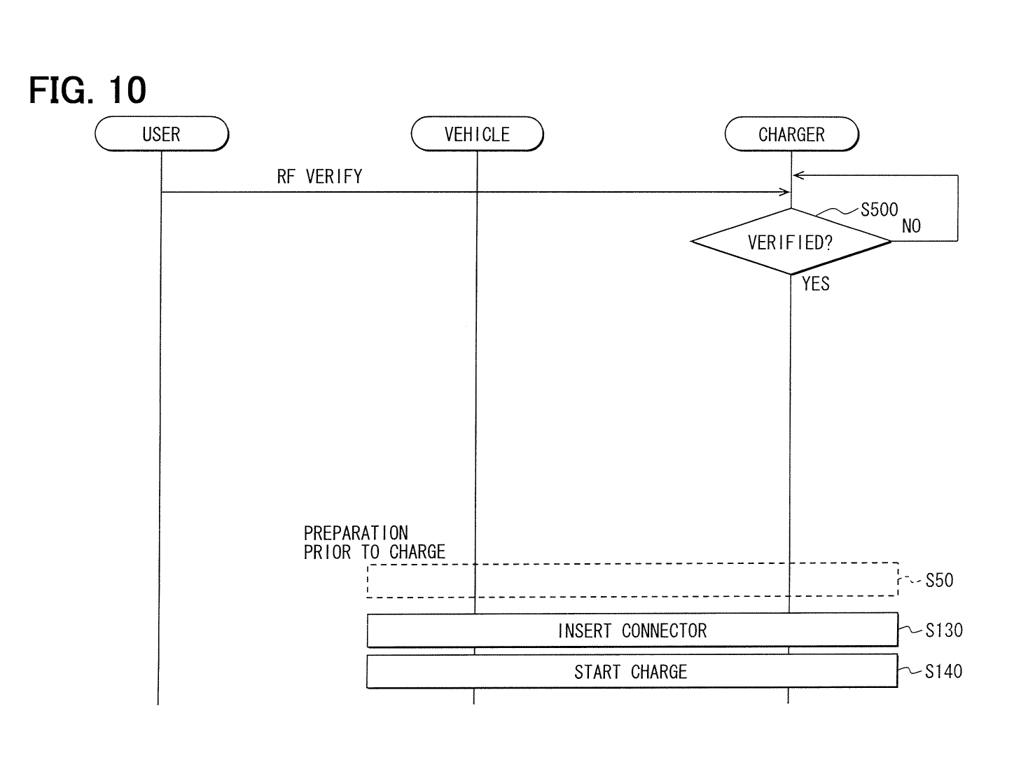

The vehicular charge apparatus 100 (100E) according to a fifth embodiment is illustrated in FIG. 9 and FIG. 10. In the fifth embodiment, the detection section which detects that it is in the charge needed state is different from that of the above first embodiment (FIG. 1, FIG. 2). The detection section of the fifth embodiment includes a verification section 118 and the in-charger controller 114, as illustrated in FIG. 9.

In the vehicular charge apparatus 100E of the present embodiment, in executing a charge, a user needs to execute an RF verification to the verification section 118 of the charger 110. It is noted that the verification may be referred to as authentication or certification. The RF verification is executed as follows. First, the RF signifies a radio frequency literally, further substantively signifying a radio wave communications media or means or wireless communications media or means. A user has an RF tag such as an IC card or cellular phone which contains information on user him/herself. The user holds the RF tag close to the verification section 118. Using a short distance wireless communications means adopting an electromagnetic field or electric wave, etc., enables the data exchange of the user's information with the charger 110.

The verification section 118 is a verification means to read user's information in the RF tag. For example, the verification section 118 is provided in a side wall of the charger 110. The verification section 118 can accept the RF tag of a contact type or a non-contact type (a near-field communication such as Felica (trade mark)). The user's information read by the verification section 118 is outputted to the in-charger controller 114. When receiving the user's information, the in-charger controller 114 detects that it is in the charge needed state. The following will explain the details of the control concerning the charge preparation operation with reference to FIG. 10.

In executing a charge, the user holds an IC card or cellular phone close to or over the verification section 118 of the charger 110 to execute an RF verification. In the charger 110, at S500, the in-charger controller 114 determines whether the RF verification is successfully completed in the verification section 118 by determining the input of the user's information, When it is determined that the RF verification is successfully completed, the preparation operations needed before charge are executed in the vehicle 10 and charger 110, based on the sequence prior to charge (S50), like in the first embodiment.

In the present embodiment, the detection section includes the verification section 118 and the in-charger controller 114. When the RF verification is executed, the in-charger controller 114 receives the user's information, thereby detecting that there is a necessity for charge. Like in the first embodiment, the necessity for charge reflecting the intention for the charge of the user is detectable.

### Sixth Embodiment

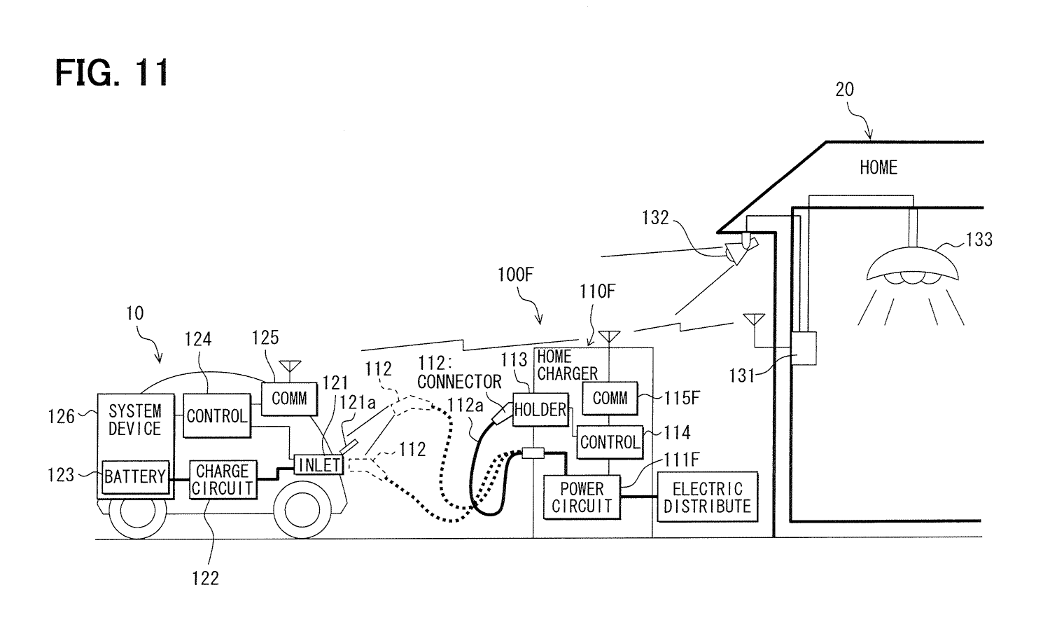

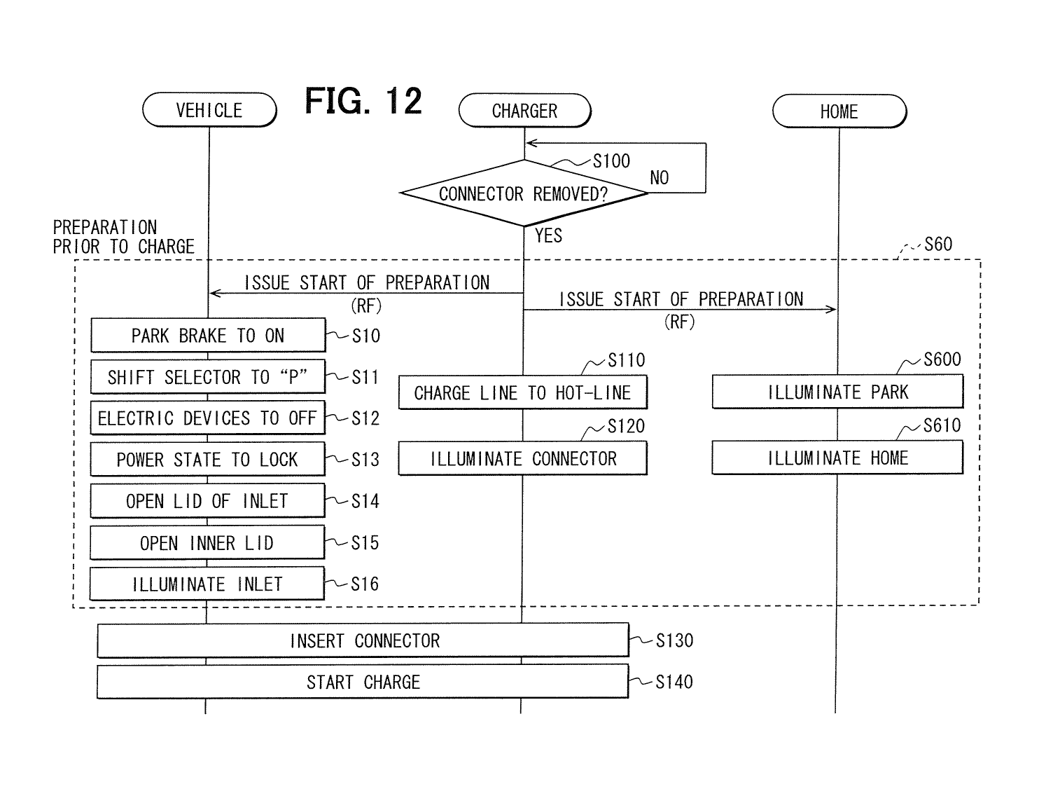

The vehicular charge apparatus 100 (100F) according to a sixth embodiment is illustrated in FIG. 11 and FIG. 12. In the sixth embodiment, as compared with the first embodiment (FIGS., 1, 2), the charger 110 is a home charger 110F that is arranged in a user's home or house (residence) 20. Thus, the home 20 may serve as a charge facility. In executing a charge, preparation operations for the charge are also executed in the home 20.

The home charger 110F usually charges in the user's home 20. The single phase 100V or 200V of AC power is supplied to the home charger 110F as an electric distribution of a system power. As compared with the quick charge at the charge station (e.g., 30 minutes), the home charger 110F executes a charge over a longer time (e.g., seven hours for 100V and 14 hours for 200V). Therefore, the home charger 110F executes mainly a charge during the nighttime when the vehicle 10 is parked at a parking area or lot of the home 20 after the user uses the vehicle 10 in the daytime.

The basic configuration of the home charger 110F is the same as that of the charger 110 of the above first embodiment. The functions of the power circuit 111F and the in-charger communicator 115F differ to some extent.

The power circuit 111F adjusts the single phase 100V or 200V of the AC power for home use to the current quantity according to the charge amount of the in-vehicle battery 123; at the same time, the AC power is directly supplied as-is to the charger connector 112. It is noted that the charge circuit 122 in the vehicle 10 is provided with an AC-DC conversion function in addition to the DC-DC conversion function explained in the first embodiment. When the charge is executed by the home charger 110F, the charge circuit 122 converts the AC power into the DC power using the AC-DC conversion function, thereby charging the in-vehicle battery 123.

Further, the in-charger communicator 115F has a communications function with a home controller 131 in the home 20 in addition to the communications function with the in-vehicle communicator 125.

In contrast, the home controller 131 and a parking area illuminator 132 for a parking area of the home 20. The home controller 131 receives a signal outputted from the in-charger communicator 115F. Based on the received signal, the home controller 131 controls operations of the parking area illuminator 12 and predetermined home electrical devices in the home 20.

The parking area illuminator 132 is arranged under an eave of the home 20 for illuminating an area surrounding the home charger 110F and the parked vehicle 10, for example. Turning into the lighting (ON) state or non-lighting (OFF) state is controlled by the home controller 131. The above mentioned predetermined home electrical devices in the home 20 include an in-home illuminator 133 which illuminates an inside of a room. The in-home illuminator 133 is also controlled by the home controller 131 so as to turn ON or OFF. The following will explain the details of the control concerning the charge preparation operation with reference to FIG. 12.

As compared with FIG. 2 used in the first embodiment, the sequence S60 prior to charge further includes S600 and S610. Thus, S100 to S120 in the home charger 110F (preparation operations needed in the charger 110F) and S10 to S16 in the vehicle 10 (preparation operations needed in the vehicle 10) are identical to those in the FIG. 2, thereby being omitted from the explanation.

The user finishes use of the vehicle 10 in a daytime and stops the vehicle 10 in the parking area of the home 20, starting a charge at nighttime. The user removes the charger connector 112 from the connector holder 113 for charge. Then, at S100, the in-charger controller 114 of the home charger 110F detects that the charger connector 112 is removed from the connector holder 113, thereby determining that it is in the charge needed state. The in-charger controller 114 transmits a prior-charge sequence start signal indicating a start of the sequence prior to charge from the in-charger communicator 115 to the home controller 131.

Then, in the home 20, the prior-charge sequence start signal is transmitted to the home controller 131. The home controller 131 makes a preparation operation necessary for the charge in the home 20. That is, based on the outputted signal indicating the start of the sequence prior to charge, the home controller 131 turns the parking area illuminator 132 into the ON (lighting) state. In addition, at S610, the in-home illuminator 133 is turned into the ON (lighting) state.

At the same time, the preparation operations for charge in the vehicle 10 are executed at S10 to S16; the preparation operations for charge in the home charger 110F are executed at S110 and S120.

In the present embodiment, preparation operations required for the charge in home 20 in which the home charger 110F is installed can be executed automatically, thereby reducing the troublesomeness of the user accompanying the charge.

In specific, when the charge is needed, the parking area illuminator 132 for the parking area is turned into the ON state. Therefore, an area surrounding the home charger 110F is brightly illuminated by the illuminator 132 for the parking area at the time of the charge. The safety and the workability at the time of the charge can be improved. The connector illuminator is also turned into the ON state in the charger connector 112 at S120. The safety and the workability at the time of the charge can be improved.

In addition, when the charge is needed, the in-home illuminator 133 is turned into the ON state. Therefore, in cases where a user goes into the home 20 after completing an action or operation necessary for the charge, the in-home illuminator 133 is already turned into the lighting state. This enables the efficient and comfortable life without wasting time to turn on the in-home illuminator 133.

### Seventh Embodiment

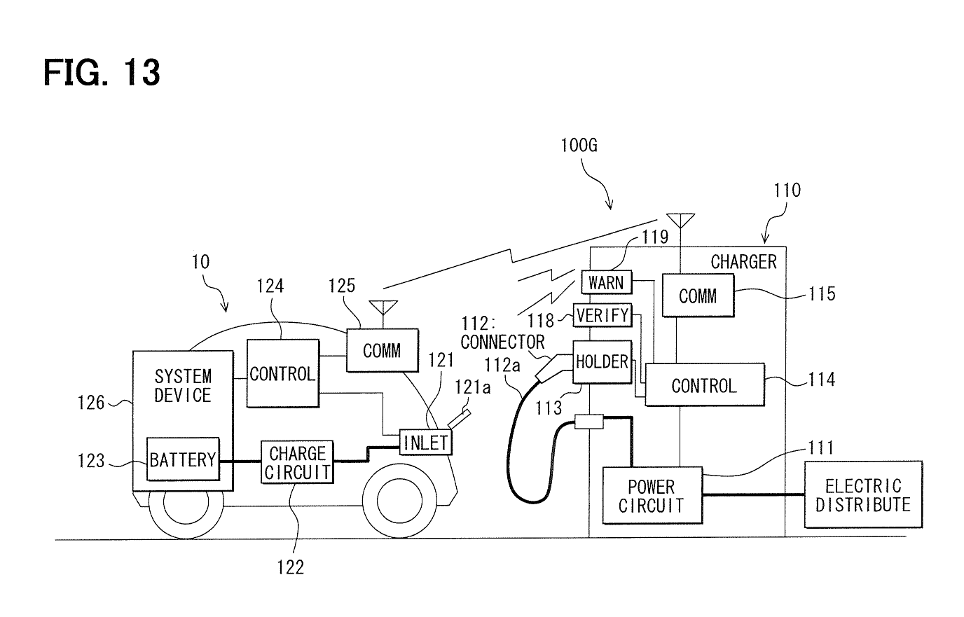

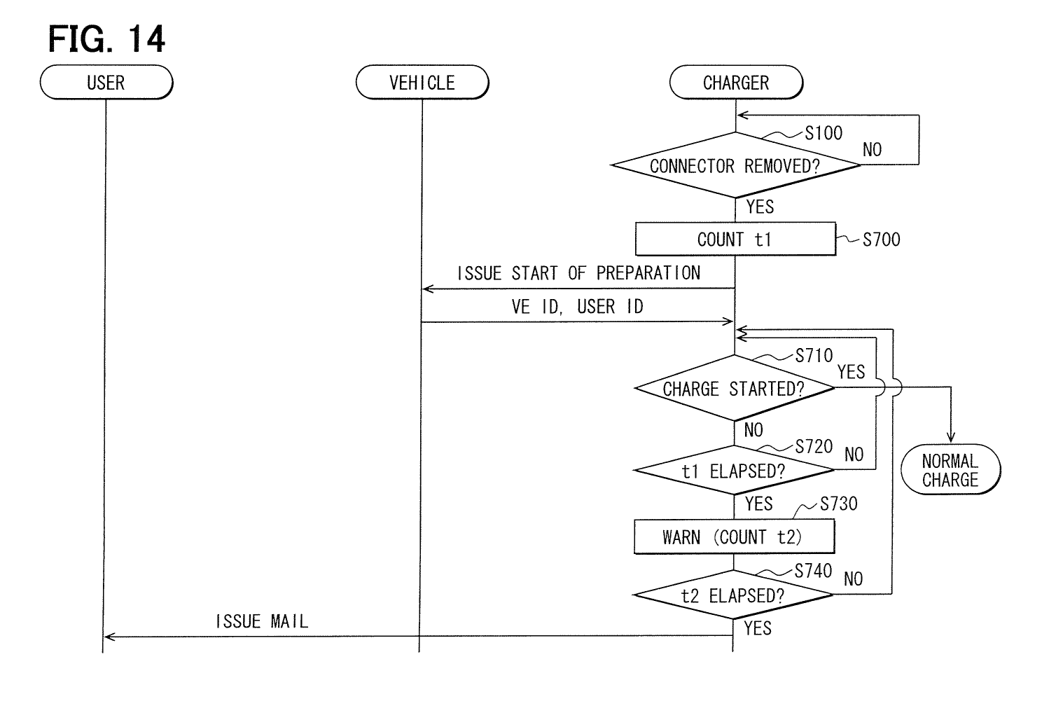

The vehicular charge apparatus 100 (100G) according to a seventh embodiment is illustrated in FIG. 13 and FIG. 14. As compared with the first embodiment (FIG. 1 and FIG. 2) , the charger 110 is provided with a warning device 119, which warns the user about the charge not correctly starting.

The warning device 119 is a warning means to generate a warning for the user using an audible tone etc., and is installed in a side wall of the charger 110, for instance. A warning operation of the warning device 119 is controlled by the in-charger controller 114. The verification section 118 explained in the above fifth embodiment is also provided in the charger 110. The following will explain the details of the control concerning the charge preparation operation with reference to FIG. 14.

First, at S100, the in-charger controller 114 of the charger 110 detects that the charger connector 112 is removed from the connector holder 113 by the user, thereby determining that for the charger 110 it is in the charge needed state. At S700, an elapsed time counter is started for measuring a time up to a predetermined time t1. The in-charger controller 114 transmits a prior-charge sequence start signal indicating a start of the sequence prior to charge from the in-charger communicator 115 to the in-vehicle communicator 125.

Then, based on the sequence prior to charge, the preparation operations needed for the charge explained in the above first embodiment are executed in the vehicle 10 and charger 110. The user connects the charger connector 112 to the charge inlet 121, and starts charge (subsequent processing is omitted in FIG. 14). In executing the charge, the user holds an IC card or cellular phone close to or over the verification section 118 of the charger 110 to execute an RF verification. Then, the user's information (for example, the user ID, vehicle ID) is outputted to the in-charger controller 114 from the verification section 118.

In the charger 110, at S710, the in-charger controller 114 determines whether the charge is started or not (i.e., whether the charger connector 112 is connected to the charge inlet 121). This is determined, for example, based on the operating state of the power circuit 111. When determining that the charge is started correctly, the in-charger controller 114 continues the usual charging process as it is. In contrast, when determining at S710 that the charge is not started, advancing to S720. When the charge is not started, there may be a case where the charger connector 112 is not correctly inserted into the charge inlet 121. In such a case, the power circuit 111 does not operate correctly.

At S720, the in-charger controller 114 determines whether the elapsed time started at S700 by the counter exceeds the time t1. With the negative determination at S720, S710 and S720 are repeated. In contrast, with the affirmative determination at S720, it is determined that the elapsed time exceeds the time t1. Thus, the warning device 119 is operated at S730, sounding the warning for the user while starting a counter to measure an elapsed time up to a time t2.

When it is determined that the elapsed time exceeds the time t2 at S740, the in-charger controller 114 transmits, to the cellular phone of the user corresponding to the user ID, an email indicating that the charge is not started correctly.

In a usual case, the removal of the charger connector 112 from the connector holder 113 signifies the execution of the charge. In cases that after the predetermined time t1 passes, the charge in the charger 110 is not started (i.e., the charger connector 112 is not connected to the charge inlet 121), it is assumed that a certain failure arises in the charge operation. In the present embodiment, the user is warned of such an abnormal state without the charge completed correctly, helping prevent the user from mistakenly understanding that the charge is completed.

The in-charger controller 114 also transmits, to the cellular phone of the user, an email indicating that the charge is not started correctly after the warning. Thus, the user's attention can be certainly drawn.

### Eighth Embodiment

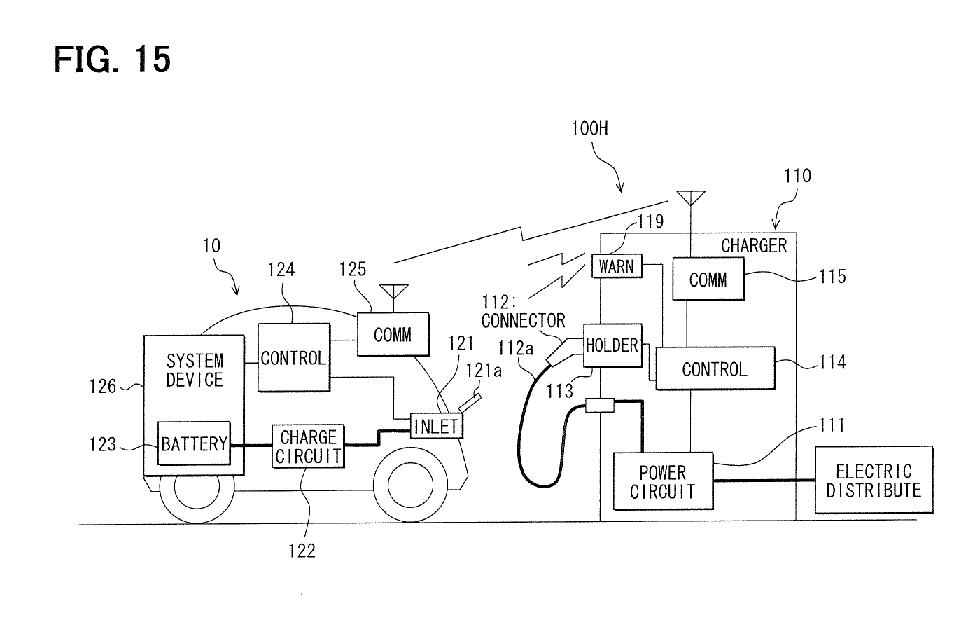

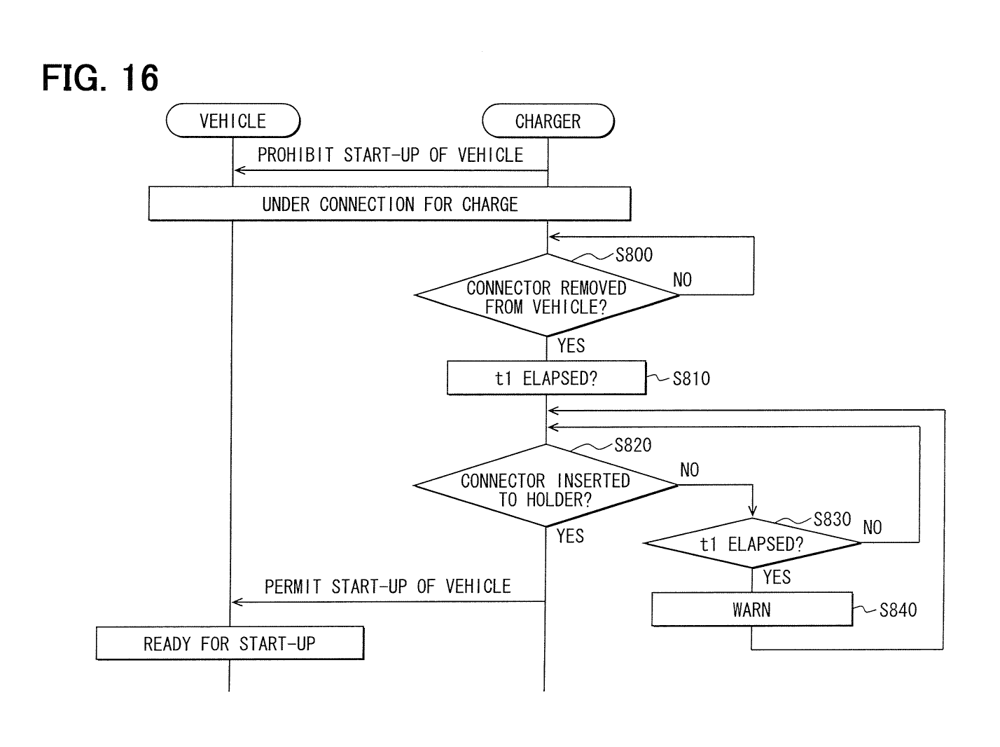

The vehicular charge apparatus 100 (100H) according to an eighth embodiment is illustrated in FIG. 15 and FIG. 16. As compared with the first embodiment (FIG. 1 and FIG. 2), the charger 110 is provided with the warning device 119 explained in the seventh embodiment for warning the user when the charger connector 112 is not returned into the connector holder 113. The following will explain the details of the control after the completion of the charge with reference to FIG. 16.

While the charge is executed in the vehicle 10 by the charger 110 in FIG. 16, the in-charger controller 114 transmits a vehicle start-up prohibition command which prohibits the vehicle 10 from starting up, for safety. That is, in the vehicle 10, the power switch is maintained in the locking position, causing the vehicle 10 to be in a start-up disabled state. When the charge is completed, the in-charger controller 114 determines at S800 whether the charger connector 112 is removed from the charge inlet 121 of the vehicle 10. When it is determined that the charger connector 112 is removed, an elapsed time counter is started for measuring a time up to a predetermined time t1 at S810.

Then, at S820, it is determined whether the charger connector 112 is returned and held or inserted in the connector holder 113 of the charger 110. When determining that the charger connector 112 is held in the connector holder 113, the in-charger controller 114 transmits a vehicle start-up permission command which permits the vehicle 10 to start up. Then, the vehicle 10 advances to the state (Ready state) where the vehicle 10 is ready for a start-up.

When determining at S820 that the charger connector 112 is not held in the connector holder 113, the in-charger controller 114 determines whether the elapsed time by the counter exceeds the time t1 at S830. With the negative determination at S830, S820 is repeated. When it is determined that the elapsed time exceeds the time t1 at S830, the warning device 119 is operated at S840, outputting a warning to the user. In a usual case, when the charge is completed, the user should return the charger connector 112 to the connector holder 113. Since returning of the charger connector 112 is not completed, the user is drawn to the cautions.

As explained above, when the charge is completed, the user generally returns the charger connector 112 to the connector holder 113. In cases that the returning of the charger connector 112 is not made, it is supposed that the charge operation is not completed correctly. In such a state, the vehicle start-up prohibition command is transmitted to the vehicle 10 so as to warn the user, helping prevent the charge from being ended without being correctly completed.

In the present embodiment, when after the completion of the charge, the charger connector 112 is not returned to the connector holder 113, the warning device 119 is caused to warn the user. There is no need to be limited thereto. That is, after the completion of the charge, the user's RF may be verified. When the charger connector 112 is then not returned to the connector holder 113, an email may be transmitted to the cellular phone of the user for indicating that the charge is not correctly completed.

### Ninth Embodiment

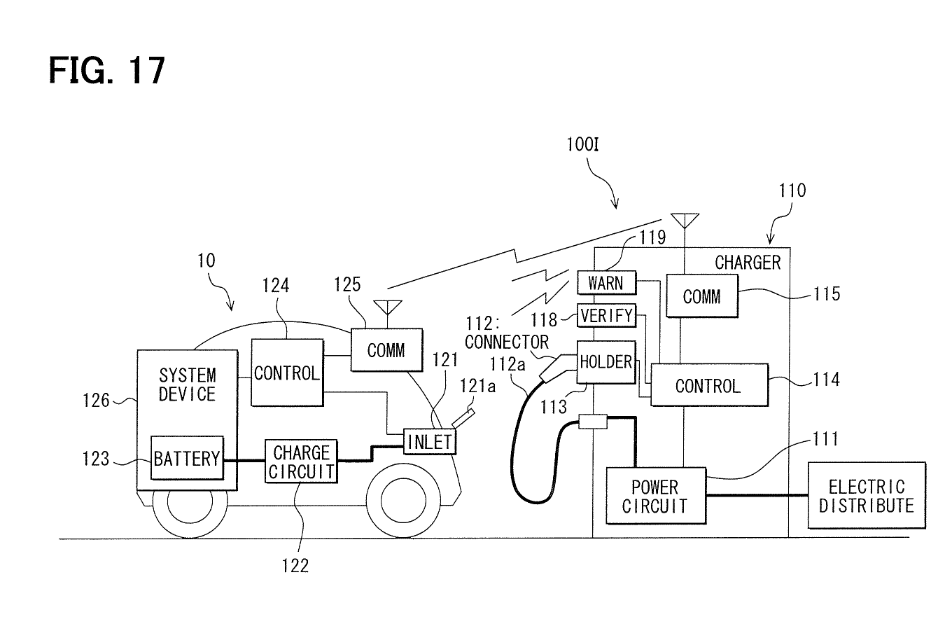

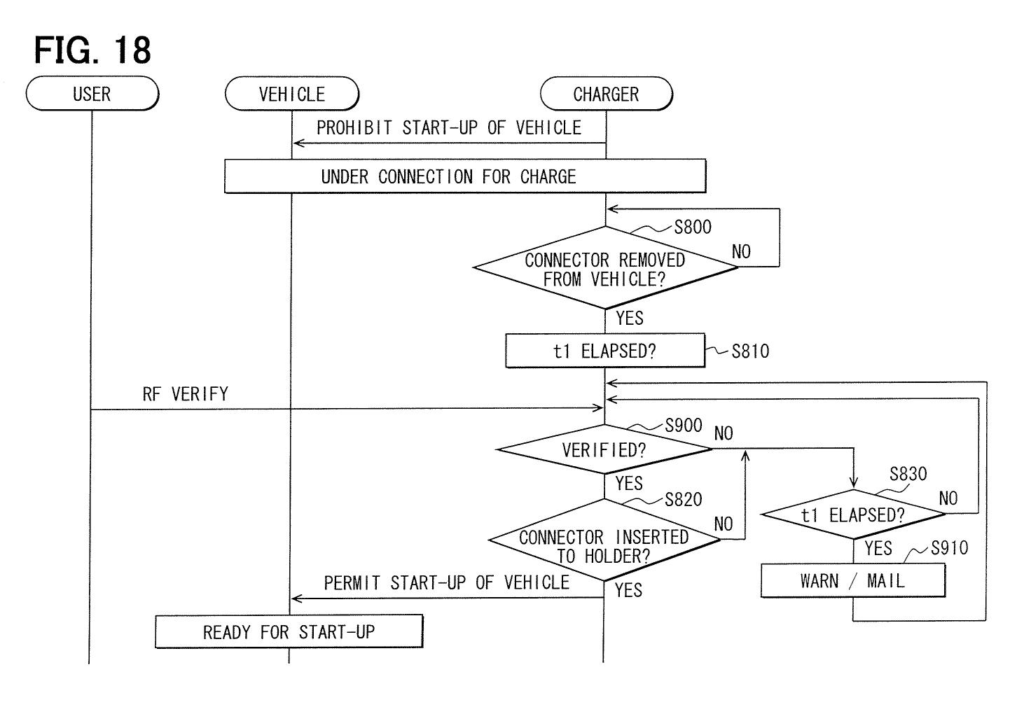

The vehicular charge apparatus 100 (100I) according to a ninth embodiment is illustrated in FIG. 17 and FIG. 18. As compared with the eighth embodiment (FIG. 15 and FIG. 16), the charger 110 is provided with the verification section 118 explained in the seventh embodiment for warning the user when the RF verification is not made after the completion of the charge. The following will explain the details of the control after the completion of the charge with reference to FIG. 18. As compared with FIG. 16 of the eighth embodiment, after the completion of the charge, the RF verification of the user is made while adding S900 and substituting S910 for S840.

While the charge is executed in the vehicle 10 by the charger 110 in FIG. 18, the in-charger controller 114 transmits a vehicle start-up prohibition command which prohibits the vehicle 10 from starting, for safety. When the charge is completed, the in-charger controller 114 determines at S800 whether the charger connector 112 is removed from the charge inlet 121 of the vehicle 10. When it is determined that the charger connector 112 is removed, an elapsed time counter is started for measuring a time up to a predetermined time t1 at S810.

After the completion of the charge, the user holds an IC card or cellular phone close to or over the verification section 118 of the charger 110 to execute an RF verification. Then, the user's information (for example, the user ID, vehicle ID) is outputted to the in-charger controller 114 from the verification section 118.

At S900, the in-charger controller 114 then determines whether the RF verification is carried out from user's information. Then, at S820, it is determined whether the charger connector 112 is returned and held or inserted in the connector holder 113 of the charger 110. When affirmative determination is carried out at both S900 and S820, the in-charger controller 114 transmits a vehicle start-up permission command which permits the vehicle 10 to start up. Then, the vehicle 10 advances to the state (Ready state) where the vehicle 10 is ready for a start-up.

With the negative determination at S900 or S820, the in-charger controller 114 determines whether the elapsed time by the counter exceeds the time t1 at S830. With the negative determination at S830, S820 and S830 are repeated. In contrast, when it is determined that the elapsed time exceeds the time t1 at S830, the warning device 119 is operated at S910, outputting a warning to the user. In addition, an email may be transmitted to the cellular phone of the user for indicating that the charge is not correctly completed.

As mentioned above, in the present embodiment, the RF verification is made after the completion of charge. In cases that the RF verification is not made, it is supposed that the charge operation is not completed correctly. In such a state, a vehicle start-up prohibition command is transmitted to the vehicle 10. The user is warned by the warning device 119. Further, an email is transmitted to the cellular phone. This can help prevent the charge from being ended without being correctly completed.

### Other Embodiments

In the above embodiments, the method to detect the charge needed state includes one to detect that the charger connector 112 is removed from the connector holder 113, one to detect that the vehicle 10 approaches using the sensor 116, one to detect that the vehicle type information of the vehicle 10 belongs to an electric vehicle, one to detect that the charge request switch 117 or 127 is turned into the ON state, and one to detect that the user's RF verification is executed successfully. Without need to be limited thereto, when it is detected that the user stands in front of the charger 110, the charge needed state may be determined or detected.

Further, in the above embodiments, the preparation operations for charge in the vehicle include: turning on a parking brake; shifting a selector for transmission of the vehicle to a parking position; stopping all electrical devices such as a headlight and an air-conditioner; changing the power switch into the lock position; switching the lid portion 121a of the charge inlet 121 into the opened state; switching the inner lid of the charge inlet 121 into the opened state; and turning the indicator light into the ON state. Without need to be limited thereto, among the above preparation operations, at least one may be executed as needed.

Further, the preparation operations for charge in the charger 110 include: switching the power circuit 111, the cable 112a, and the charger connector 112 into the hot-link state enabling the charger; and turning the illuminator in the charger connector 112 into the ON state or lighting state. Without need to be limited thereto, among the above preparation operations, at least one may be executed as needed.

In addition, in the sixth embodiment, the preparation operations in the user's home 20 include turning the in-home illuminator 133 into the ON state. There is no need to be limited thereto. the air-conditioner may be operated; the hot-water supply apparatus may be activated and start the supplying the hot-water to the bath; and the TV set is turned into the ON state.

In addition, in the above sixth embodiment, the home charger 110F is installed in the user's home 20. In cases where the charger 110 is installed in the station (i.e., charge facility), an illuminator for the charger may be provided in the station to illuminate an area surrounding the charger 110. When it is determined that the charge is in the needed state (S100), the above illuminator may be turned into the lighting (ON) state.

In addition, in the eighth and ninth embodiments, when the charger connector 112 is detected to be returned to the connector holder 113, i.e., when the completion of the charge is detected, the in-charger controller 114 may be switched from the charge execution mode into the detection mode where to detect whether the charge is in the needed state. Such a case or configuration enables the charger 110 to fulfill the overall function.

In addition, in the charger and the vehicle, the charger connector and the charge inlet may be not provided. The charge may be executed in the non-contact state using the charge coil of the charger. In such a configuration, the detection as to whether the charge is in the needed state may be made by detecting that the power receiving section (vehicle) and the power transmission section (coil for charge) are arranged in the charge enabled state.

Each or any combination of sections explained in the above can be achieved as (i) a software section in a combination with a hardware device (e.g., computer or CPU) and/or (ii) a hardware section (e.g., circuit or integrated circuit), including or not including a function of a related device; furthermore, the hardware section may be constructed inside of a microcomputer.

Furthermore, the software section or any combinations of several software sections may be included in a software program, which may be contained in a non-transitory computer-readable storage media or may be downloaded via a communications link or network and then stored in a non-transitory computer-readable storage media.

Aspects of the disclosure described herein are set out in the following clauses.

As an aspect of the disclosure, a vehicular charge apparatus including a charger is provided for supplying an electric power to charge an in-vehicle battery mounted in a vehicle after a user completes a charge connection, which connects a charger connector of the charger with an in-vehicle charge inlet of the vehicle. The charger includes the following: a detection section that detects, of the vehicle, a charge needed state in which an electric charge is needed for the vehicle, prior to completing the charge connection of the charger connector with the in-vehicle charge inlet; an in-charger communicator that communicates with an in-vehicle communicator in the vehicle; and an in-charger controller that controls an operation of an electric charge. Herein, when the detection section detects the charge needed state of the vehicle, the in-charger controller executes a charge preparation operation necessary in the charger, and transmits charge information, which indicates that the vehicle is in the charge needed state, via the in-charger communicator to the in-vehicle communicator, causing an in-vehicle charge preparation section in the vehicle to begin a charge preparation operation necessary in the vehicle when the in-vehicle communicator receives the charge massage from the in-charger communicator.

As an optional aspect of the disclosure, in the above vehicular charge apparatus, the charger may further include a connector holder that holds the charger connector when the charger connector is not used. When the charger connector is removed from the connector holder, the detection section may detect the charge needed state.

As an optional aspect of the disclosure, in the above vehicular charge apparatus, the charger may further include a sensor which recognizes a presence of the vehicle within a predetermined distance. When the sensor recognizes the presence of the vehicle within the predetermined distance, the detection section may detect the charge needed state.

In the above optional aspect, further when the in-charger communicator receives from the in-vehicle communicator information indicating that the vehicle belongs to an electric vehicle, the detection section may detect the charge needed state of the vehicle.

Thus, the charge needed state of the vehicle can be detected when the vehicle having entered within the predetermined distance is determined to belong to an electric vehicle. The detection about the necessity for charge can be made accurately.

As an optional aspect of the disclosure, in the above vehicular charge apparatus, when the in-charger communicator receives from the in-vehicle communicator information indicating that an in-vehicle charge request switch in the vehicle is turned into an ON state by the user to request a start of an electric charge, the detection section may detect the charge needed state of the vehicle.

Thus, the necessity for charge reflecting the intention for the charge of the user is detectable.

As an optional aspect of the disclosure, in the above vehicular charge apparatus, the charger may further include an in-charger charge request switch for the user to request a start of an electric charge. When the in-charger charge request switch is turned into an ON state by the user, the detection section may detect the charge needed state of the vehicle.

Similarly, the necessity for charge reflecting the intention for the charge of the user is detectable.

As an optional aspect of the disclosure, in the above vehicular charge apparatus, the charger may further include a verification section to verify information belonging to the user. When the verification section successfully verifies the information belonging to the user, the detection section may detect the charge needed state.

Similarly, the necessity for charge reflecting the intention for the charge of the user is detectable.

As an optional aspect of the disclosure, in the above vehicular charge apparatus, the charge preparation of the in-vehicle charge preparation section may include at least one of: (i) applying a parking brake of the vehicle; (ii) shifting a selector for transmission of the vehicle to a parking position; (iii) opening of a lid portion of the charge inlet of the vehicle; (iv) switching the vehicle into a state where an electric charge is enabled; (v) turning electrical devices mounted in the vehicle into an OFF state; and (vi) turning an illuminator in the charge inlet of the vehicle into a lighting state.

Thus, a preparation operation which the user has to perform or manipulate in a conventional technology can be automatically executed. Such a configuration can reduce a troublesomeness of the user in the case of charging the vehicle.

As an optional aspect of the disclosure, in the above vehicular charge apparatus, the charge preparation executed by the in-charger controller may include at least one of: (i) switching a charge link connected from a power source to the charger connector into a hot-link state which enables the charge for the vehicle; and (ii) turning an illuminator in the charger connector into a lighting state.

Thus, similarly, a preparation operation which the user has to perform or manipulate in a conventional technology can be automatically executed. Such a configuration can reduce a troublesomeness of the user in the case of charging the vehicle.

As an optional aspect of the disclosure, in the above vehicular charge apparatus, when the detection section detects the charge needed state of the vehicle, the in-charger controller may transmit via the in-charger communicator the charge information to a charge facility, which includes one of (i) a charge station housing the charger and (ii) a home of the user, causing the charge facility to begin a charge preparation necessary in the station.

Therefore, a preparation operation can be made even in the charge facility such as home or charge station, thereby reducing the troublesomeness of the user accompanying the charge.

Further, in the above, the charge facility may include an illuminator arranged near the charger to illuminate an area surrounding the charger. The charge preparation in the charge facility may include turning the illuminator in the charge facility into a lighting state.

Therefore, an area surrounding the charger is brightly illuminated by the illuminator for the charger at the time of the charge. The safety and the workability at the time of the charge can be improved.

Furthermore, the charge preparation in the charge facility may include turning a predetermined electrical devices into an operating state.

Therefore, for instance, when the user enters inside of the home, a predetermined electrical device has been already operating. This enables the efficient and comfortable life without wasting time to turn on the in-home illuminator 133.

Furthermore, the in-charger controller may warn the user in cases that a predetermined duration elapses without the charger connector connected to the in-vehicle charge inlet since the charger connector is removed from the connector holder.

Usually, removing the charger connector from the connector holder signifies that the charge action is being executed. In case that a predetermined time elapses without the charger connector connected to the charge inlet, it is assumed that a certain failure arises in the charge operation. Therefore, warning the user under such a situation without the charge completed correctly can help prevent the user from mistakenly understanding that the charge is completed.

Furthermore, in cases that the charger connector is not held in the connector holder after the electric charge is completed, the in-charger controller may transmit via the in-charger communicator to the in-vehicle communicator a vehicle start-up prohibition instruction to prohibit a start-up of the vehicle while warning the user.

When the charge is completed, the user generally returns the charger connector to the connector holder. In cases that the returning of the charger connector is not made, it is supposed that the charge operation is not completed correctly. In such a state, a vehicle start-up prohibition command is transmitted to the vehicle to warn the user. This can help prevent the charge from being ended without being correctly completed.

As an optional aspect of the disclosure, in the above vehicular charge apparatus, when verifying information belonging to the user is not executed by the user after the electric charge is completed, the in-charger controller may transmit via the in-charger communicator to the in-vehicle communicator a vehicle start-up prohibition instruction to prohibit a start-up of the vehicle while warning the user.

It is premised that after completing the charge, a verification is made by the user. In such a condition, if the verification is not made, it is supposed that the charge action is not completed correctly. In such a state, a vehicle start-up prohibition command is transmitted to the vehicle to warn the user. This can help prevent the charge from being ended without being correctly completed.

It will be obvious to those skilled in the art that various changes may be made in the above-described embodiments of the present invention. However, the scope of the present invention should be determined by the following claims.

What is claimed:

1. A vehicular charge apparatus including a charger for supplying an electric power to charge an in-vehicle battery mounted in a vehicle after a user completes a charge connection, which connects a charger connector of the charger with an in-vehicle charge inlet of the vehicle,
the charger comprising:
a detection section that detects, of the vehicle, a charge needed state in which an electric charge is needed for the vehicle, prior to completing the charge connection of the charger connector with the in-vehicle charge inlet;
an in-charger communicator that communicates with an in-vehicle communicator in the vehicle; and
an in-charger controller that controls an operation of an electric charge,
wherein
when the detection section detects the charge needed state of the vehicle, the in-charger controller executes a charge preparation operation necessary in the charger, and transmits charge information, which indicates that the vehicle is in the charge needed state, via the in-charger communicator to the in-vehicle communicator, causing an in-vehicle charge preparation section in the vehicle to begin a charge preparation operation necessary in the vehicle when the in-vehicle communicator receives the charge massage from the in-charger communicator.

2. The vehicular charge apparatus according to claim 1, wherein:
the charger further comprises a connector holder that holds the charger connector when the charger connector is not used; and
when the charger connector is removed from the connector holder, the detection section detects the charge needed state.

3. The vehicular charge apparatus according to claim 1, wherein:
the charger further comprises a sensor which recognizes a presence of the vehicle within a predetermined distance; and
when the sensor recognizes the presence of the vehicle within the predetermined distance, the detection section detects the charge needed state.

4. The vehicular charge apparatus according to claim 3, wherein
further when the in-charger communicator receives from the in-vehicle communicator information indicating that the vehicle belongs to an electric vehicle, the detection section detects the charge needed state of the vehicle.

5. The vehicular charge apparatus according to claim 1, wherein
when the in-charger communicator receives from the in-vehicle communicator information indicating that an in-vehicle charge request switch in the vehicle is turned into an ON state by the user to request a start of an electric charge, the detection section detects the charge needed state of the vehicle.

6. The vehicular charge apparatus according to claim 1, wherein:
the charger further comprises an in-charger charge request switch for the user to request a start of an electric charge; and
when the in-charger charge request switch is turned into an ON state by the user, the detection section detects the charge needed state of the vehicle.

7. The vehicular charge apparatus according to claim 1, wherein:
the charger further comprises a verification section to verify information belonging to the user; and
when the verification section successfully verifies the information belonging to the user, the detection section detects the charge needed state.

8. The vehicular charge apparatus according to claim 1, wherein
the charge preparation of the in-vehicle charge preparation section includes at least one of:
(i) applying a parking brake of the vehicle;
(ii) shifting a selector for transmission of the vehicle to a parking position;
(iii) opening of a lid portion of the charge inlet of the vehicle;
(iv) switching the vehicle into a state where an electric charge is enabled;
(v) turning electrical devices mounted in the vehicle into an OFF state; and
(vi) turning an illuminator in the charge inlet of the vehicle into a lighting state.

9. The vehicular charge apparatus according to claim 1, wherein the charge preparation executed by the in-charger controller includes at least one of:
(i) switching a charge link connected from a power source to the charger connector into a hot-link state which enables the charge for the vehicle; and
(ii) turning an illuminator in the charger connector into a lighting state.

10. The vehicular charge apparatus according to claim 1, wherein
when the detection section detects the charge needed state of the vehicle, the in-charger controller transmits via the in-charger communicator the charge information to a charge facility, which includes one of (i) a charge station housing the charger and (ii) a home of the user, causing the charge facility to begin a charge preparation necessary in the station.

11. The vehicular charge apparatus according to claim 10, wherein:
the charge facility includes an illuminator arranged near the charger to illuminate an area surrounding the charger; and
the charge preparation in the charge facility includes turning the illuminator in the charge facility into a lighting state.

12. The vehicular charge apparatus according to claim 10, wherein the charge preparation in the charge facility includes turning a predetermined electrical devices into an operating state.

13. The vehicular charge apparatus according to claim 2, wherein the in-charger controller warns the user in cases that a predetermined duration elapses without the charger connector connected to the in-vehicle charge inlet since the charger connector is removed from the connector holder.

14. The vehicular charge apparatus according to claim 2, wherein in cases that the charger connector is not held in the connector holder after the electric charge is completed, the in-charger controller transmits via the in-charger communicator to the in-vehicle communicator a vehicle start-up prohibition instruction to prohibit a start-up of the vehicle while warning the user.

15. The vehicular charge apparatus according to claim 1, wherein when verifying information belonging to the user is not executed by the user after the electric charge is completed, the in-charger controller transmits via the in-charger communicator to the in-vehicle communicator a vehicle start-up prohibition instruction to prohibit a start-up of the vehicle while warning the user.

16. A method for supplying from a charger an electric power to charge an in-vehicle battery mounted in a vehicle after a user completes a charge connection, which connects a charger connector of the charger with an in-vehicle charge inlet of the vehicle,
the charger including an in-charger controller and an in-charger communicator, the vehicle including an in-vehicle controller and an in-vehicle communicator,
the method comprising:
determining by the in-charger controller using a detection section, a charge needed state in which an electric charge is needed for the vehicle, prior to completing the charge connection of the charger connector with the in-vehicle charge inlet;
executing by the in-charger controller a charge preparation operation necessary in the charger for the charge when the charge needed state is determined;
transmitting by the in-charger controller charge information, which indicates that the vehicle is in the charge needed state, via the in-charger communicator to the in-vehicle communicator when the charge needed state is determined;
receiving by the in-vehicle controller via the in-vehicle communicator the charge information from the charger; and
executing by the in-vehicle controller using an in-vehicle charge preparation section of the vehicle a charge preparation operation necessary in the vehicle for the charge when the charge massage is received.
